(19) United States
(12) Patent Application Publication
(10) Pub. No.: US 2022/0092354 A1
(43) Pub. Date: Mar. 24, 2022

(54) METHOD AND SYSTEM FOR GENERATING LABELED DATASET USING A TRAINING DATA RECOMMENDER TECHNIQUE

(71) Applicant: Tata Consultancy Services Limited, Mumbai (IN)

(72) Inventors: Shruti Kunde, Thane West (IN); Mayank Mishra, Thane West (IN); Rekha Singhal, Thane West (IN); Amey Pandit, Thane West (IN); Manoj Nambiar, Thane West (IN); Gautam Shroff, Gurgaon (IN)

(73) Assignee: Tata Consultancy Services Limited, Mumbai (IN)

(21) Appl. No.: 17/471,564

(22) Filed: Sep. 10, 2021

(30) Foreign Application Priority Data
Sep. 21, 2020 (IN) 202021040930

(51) Int. Cl. G06K 9/62; G06N 20/00

(52) U.S. Cl. CPC G06K 9/6259; G06N 20/00; G06K 9/6232

(57) ABSTRACT

This disclosure relates generally to a method and system for generating labelled dataset using a training data recommender technique. Recommender systems face major challenges in handling dynamic data on machine learning paradigms thereby rendering inaccurate unlabeled dataset. The method of the present disclosure is based on a training data recommender technique suitably constructed with a newly defined parameter such as the labelled data prediction threshold to determine the adequate amount of labelled training data required for training the one or more machine learning models. The method processes the received unlabeled dataset for labelling the unlabeled dataset based on a labelled data prediction threshold which is determined using a trained training data recommender technique. This labelling data threshold leads to a significant reduction in training time while performing the one or more machine learning models and thus recommender systems to quickly adapt disruptions thereby decreasing the reduction factor.

### CROSS-REFERENCE TO RELATED APPLICATIONS AND PRIORITY

This U.S. patent application claims priority under 35 U.S.C § 119 to: Indian patent Application no. 202021040930, filed on Sep. 21, 2020. The entire contents of the aforementioned application are incorporated herein by reference.

### TECHNICAL FIELD

The disclosure herein generally relates to labelling unlabeled datasets, and, more particularly, to method and system for generating labelled dataset using a training data recommender technique.

### BACKGROUND

Recommender systems are among the most pervasive machine learning paradigms that many enterprise solutions drive sales. They facilitate most e-commerce and retail businesses, by capturing the complexities of daily B2C (Business to Customer) interactions, providing meaningful and timely recommendations to the customers. Sudden disruptions in such enterprise solutions affects customer preferences drastically and render historical data ineffective for modeling. In such scenarios, enterprise solutions face major challenges in handling dynamic data on machine learning paradigms based recommender systems rendering inaccuracy, increased time recommendations which gains prime significance. However, personalized recommendations are provided to customers by training machine learning models on large amounts of historical labeled data. These historical data prove to be inefficient at labeling existing user preferences, where the machine learning model falls short when there is a new user in the system, or a new product is being launched for which there is no prior data available. Another major challenge is lack of sufficient and timely availability of labeled data.

### SUMMARY

Embodiments of the present disclosure present technological improvements as solutions to one or more of the above-mentioned technical problems recognized by the inventors in conventional systems. For example, in one embodiment, a system for generating labelled dataset using a training data recommender is provided. The system includes receiving by a labeling function generator, (i) an unlabeled dataset, and (ii) a labelled dataset comprising a training data and a test data. Further, from the labelled dataset a plurality of feature subsets is extracted from the labeled dataset. The plurality of feature subsets extracted from the labeled dataset are then fed to a one or more machine learning models. Further, a plurality of labelling functions is generated for the corresponding labelled dataset using the one or more trained machine learning models. The plurality of labelling functions is executed for processing the unlabeled dataset to generate a sparse matrix. Then, using a snorkel generative model for the sparse matrix is constructed to label the unlabelled dataset. Further, the one or more machine learning models are trained with adequate amount of labelled dataset for labelling the unlabeled dataset based on a labelled data prediction threshold which is determined using a training data recommender technique.

In one embodiment, the training data recommender technique is determined by, obtaining, a plurality of labeled dataset threshold parameters comprising (i) an initial labeled dataset, (ii) a reduction factor, (iii) the test data, and (iv) a labelled data prediction threshold. Then, a plurality of prediction accuracy metrics of the test data associated with the labelled dataset is determined based on the one or more machine learning models. Then, computes, a selected labeled data, for each machine learning model is based on at least one of (i) the initial labeled dataset, and (ii) the reduction factor and the adequate amount of the labeled dataset for training the one or more machine learning models is determined based on (i) the selected labeled data, (ii) the prediction accuracy metrics of the test data, and (iii) the labelled data prediction threshold.

In another aspect, a method for generating labelled dataset using a training data recommender is provided. The method includes receiving by a labeling function generator, (i) an unlabeled dataset, and (ii) a labelled dataset comprising a training data and a test data. Further, from the labelled dataset a plurality of feature subsets is extracted from the labeled dataset. The plurality of feature subsets extracted from the labeled dataset are then fed to a one or more machine learning models. Further, a plurality of labelling functions is generated for the corresponding labelled dataset using the one or more trained machine learning models. The plurality of labelling functions is executed for processing the unlabeled dataset to generate a sparse matrix. Then, using a snorkel generative model for the sparse matrix is constructed to label the unlabelled dataset. Further, the one or more machine learning models are trained with adequate amount of labelled dataset for labelling the unlabeled dataset based on a labelled data prediction threshold which is determined using a training data recommender technique.

In one embodiment, the training data recommender technique is determined by, obtaining, a plurality of labeled dataset threshold parameters comprising (i) an initial labeled dataset, (ii) a reduction factor, (iii) the test data, and (iv) a labelled data prediction threshold. Then, a plurality of prediction accuracy metrics of the test data associated with the labelled dataset is determined based on the one or more machine learning models. Then, computes, a selected labeled data, for each machine learning model based on the initial labeled dataset, and the reduction factor. Further, the adequate amount of the labeled dataset for training the one or more machine learning models is determined based on (i) the selected labeled data, (ii) the prediction accuracy metrics of the test data, and (iii) the labelled data prediction threshold.

In yet another aspect, there are provided one or more non-transitory machine readable information storage mediums comprising one or more instructions, which when executed by one or more hardware processors perform actions comprising receiving by a labeling function generator, (i) an unlabeled dataset, and (ii) a labelled dataset comprising a training data and a test data. Further, from the labelled dataset a plurality of feature subsets is extracted from the labeled dataset. The plurality of feature subsets extracted from the labeled dataset are then fed to a one or more machine learning models. Further, a plurality of labelling functions is generated for the corresponding labelled dataset using the one or more trained machine learning models. The plurality of labelling functions is executed for processing the unlabeled dataset to generate a sparse matrix. Then, using a snorkel generative model for the sparse matrix is constructed to label the unlabelled dataset. Further, the one or more machine learning models are trained with adequate amount of labelled dataset for labelling the unlabeled dataset based on a labelled data prediction threshold which is determined using a training data recommender technique.

In one embodiment, the training data recommender technique is determined by, obtaining, a plurality of labeled dataset threshold parameters comprising (i) an initial labeled dataset, (ii) a reduction factor, (iii) the test data, and (iv) a labelled data prediction threshold. Then, a plurality of prediction accuracy metrics of the test data associated with the labelled dataset is determined based on the one or more machine learning models. Then, computes, a selected labeled data, for each machine learning model is based on at least one of (i) the initial labeled dataset, and (ii) the reduction factor and the adequate amount of the labeled dataset for training the one or more machine learning models is determined based on (i) the selected labeled data, (ii) the prediction accuracy metrics of the test data, and (iii) the labelled data prediction threshold.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of a system (alternatively referred as recommender system 100), in accordance with some embodiments of the present disclosure.

FIG. 2 illustrates a high-level architectural overview of the recommender system, in accordance with some embodiments of the present disclosure.

FIG. 3 depicts a flow diagram illustrating a method for generating labeled dataset using the system of FIG. 1, in accordance with some embodiments of the present disclosure.

FIG. 4A and FIG. 4B depict flow of training data recommender technique using the system of FIG. 1, in accordance with some embodiments of the present disclosure.

FIG. 5A and FIG. 5B illustrate a performance analysis of one or more machine learning models trained with adequate amount of labelled dataset based on a labelled data prediction threshold using the system of FIG. 1, in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims.

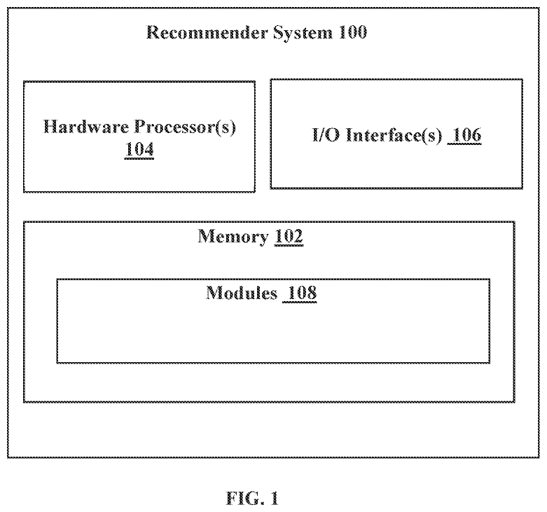

Embodiments herein provide a method and system for generating labelled dataset using a training data recommender technique. The method disclosed, enables determining adequate amount of labeled dataset required for training a one or more machine learning models. The method of the present disclosure is based on a training data recommender technique suitably constructed with one or more newly defined parameters such as the labelled data prediction threshold to determine the adequate amount of labelled training data required for training the one or more machine learning models. This labelling data threshold leads to a significant reduction in training time while performing/executing the one or more machine learning models and thus recommender systems to quickly adapt disruptions. Additionally, the method enables auto generation of labels for large amount of training dataset in a timely manner. Also, the method and system when implemented enables reduction in the latency for training the one or more machine learning models using the labelling data prediction threshold parameters. The method facilitates training the one or more machine learning models to label the unlabeled dataset based on a labelled data prediction threshold which is determined using the training data recommender technique. The disclosed system is further explained with the method as described in conjunction with FIG. 1 to FIG. 5B below.

Referring now to the drawings, and more particularly to FIG. 1 through FIG. 5B, where similar reference characters denote corresponding features consistently throughout the figures, there are shown preferred embodiments and these embodiments are described in the context of the following exemplary system and/or method.

FIG. 1 illustrates an exemplary block diagram of a system (alternatively referred as recommender system 100), in accordance with some embodiments of the present disclosure. In an embodiment, the recommender system 100 includes processor (s) 104, communication interface (s), alternatively referred as or input/output (I/O) interface(s) 106, and one or more data storage devices or memory 102 operatively coupled to the processor (s) 104. The system 100, with the processor(s) is configured to execute functions of one or more functional blocks of the system 100.

Referring to the components of the system 100, in an embodiment, the processor (s) 104 can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in the memory. In an embodiment, the system 100 can be implemented in a variety of computing systems, such as laptop computers, notebooks, 10 hand-held devices, workstations, mainframe computers, servers, a network cloud, and the like.

The I/O interface(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface (s) 106 can include one or more ports for connecting a number of devices (nodes) of the system 100 to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The modules 108 can be an Integrated Circuit (IC) (not shown), external to the memory 102, implemented using a Field-Programmable Gate Array (FPGA) or an Application-Specific Integrated Circuit (ASIC). The names (or expressions or terms) of the modules of functional block within the modules 108 referred herein, are used for explanation and are not construed to be limitation(s).

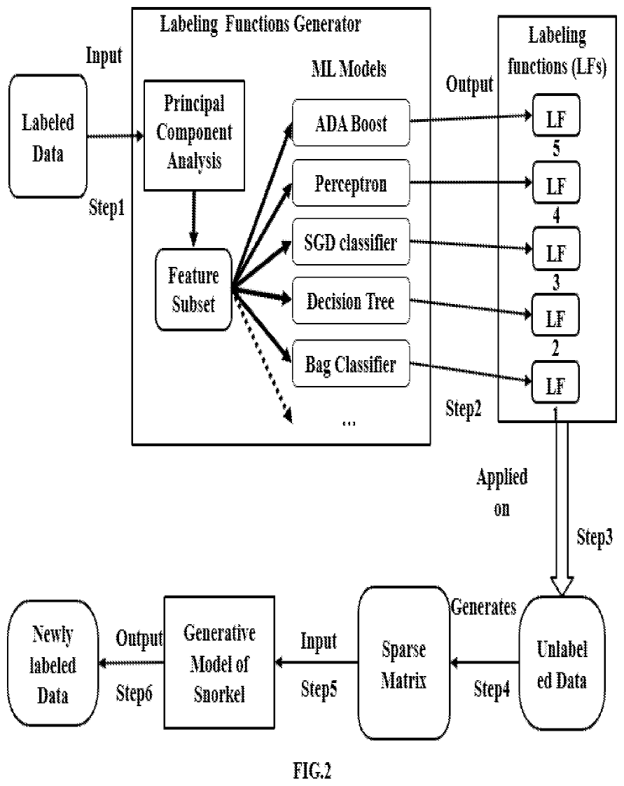

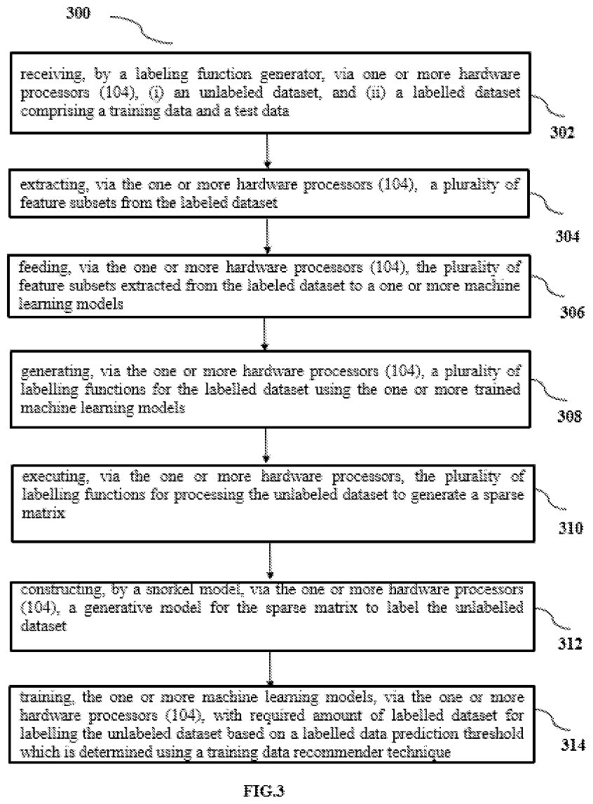

FIG. 2 illustrates a high-level architectural overview of the recommender system, in accordance with some embodiments of the present disclosure. The FIG. 2 includes a plurality of components comprising a labelling function generator, a principal component analysis, a sparse matrix generator, and a snorkel generative model. The labelling function generator comprises a feature subset generator and a one or more machine learning models. The sparse matrix generator includes a one or more rows and columns, wherein each row accommodates every unlabeled data and each column accommodates labelling functions corresponding to the one or more machine learning models. The snorkel generative model learns from the noise of the labelling functions and outputs labels for the unlabeled dataset. The principal component analysis processes the labelled dataset to obtain a plurality of feature subsets. Further, the memory 102 may comprises information pertaining to input(s)/output(s) of each step performed by the processor(s) 104 of the system 100 and methods of the present disclosure. Functions of the components of system 100, for generating labelled dataset using the training data recommender technique, are explained in conjunction with FIG. 3 through FIG. 5B providing flow diagram, architectural overviews, and performance analysis of the system 100.

FIG. 3 depicts a flow diagram illustrating a method for generating labeled dataset using the system of FIG. 1, in accordance with some embodiments of the present disclosure. In an embodiment, the system 100 comprises one or more data storage devices or the memory 102 operatively coupled to the processor(s) 104 and is configured to store instructions for execution of steps of the method 300 by the processor(s) or one or more hardware processors 104. The steps of the method 300 of the present disclosure will now be explained with reference to the components or blocks of the system 100 as depicted in FIG. 1 and FIG. 2 and the steps of flow diagram as depicted in FIG. 3. Although process steps, method steps, techniques or the like may be described in a sequential order, such processes, methods and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring now to the steps of the method 300, at step 302, the one or more hardware processors 104 receive, via a labeling function generator (i) an unlabeled dataset, and (ii) a labelled dataset comprising a training data and a test data. As a preprocessing step, the one or more machine learning models are trained over the labelled dataset and the test data is utilized for testing prediction accuracy. The present disclosure is further explained considering an example, where the system 100 is initiated to generate labelled dataset using the training data recommender technique of the system of FIG. 1 and FIG. 2. The example as described where the recommendation system 100 addresses (customer) business interactions from the bulk of dynamic data. Here, the structured dataset in a specific domain (e.g., retail domain) comprises features of users (e.g., customers, products and the transactions as a result of customers purchasing or browsing products). Using this historical data, retailers are keen on obtaining customer preference information, which enables the recommender system 100 to target specific products to customers, which may eventually turn into orders. Further, such dataset is dynamic in nature and hence labelled dataset is set to be inherent.

Referring now to the steps of the method 300, at step 304, the one or more hardware processors 104 extract a plurality of feature subset from the labeled dataset. Here, for the plurality of inputs received, a plurality of feature subset is extracted from the labelled dataset.

Referring now to the steps of the method 300, at step 306, the one or more hardware processors 104 feed, the plurality of feature subset extracted from the labeled dataset to one or more machine learning models. Referring now to FIG. 2 and considering the above example, the extracted feature subset is fed to each machine learning model from the one or more machine learning models. The one or more machine learning models include, but are not limited to, an Adaptive Boost model, a perception model, a stochastic gradient descent (SGD) classifier model, a logistic regression model, a gradient boosting machines, a XG boost, a decision tree model, a bag classifier model and thereof. These machine learning models are trained over the initial or available labeled dataset referred as a gold data. The choice and the number of machine learning models used to train the labelled dataset is based on the option selected by the user based on the specific dataset.

Referring now to the steps of the method 300, at step 308, the one or more hardware processors 104 generate a plurality of labelling functions for the labelled dataset using the one or more trained machine learning models. Referring now to FIG. 2, each model that is trained, results in labeling functions that have high accuracy among all those generated labelled dataset. The generated labeling functions are then applied on the unlabeled dataset to generate a sparse matrix.

Referring now to the steps of the method 300, at step 310, the one or more hardware processors 104 execute the plurality of labelling functions for processing the unlabeled dataset to generate a sparse matrix.

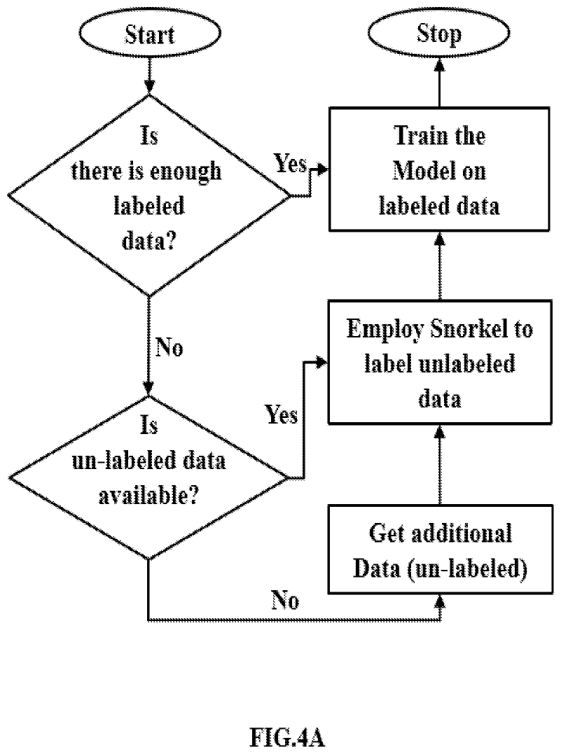

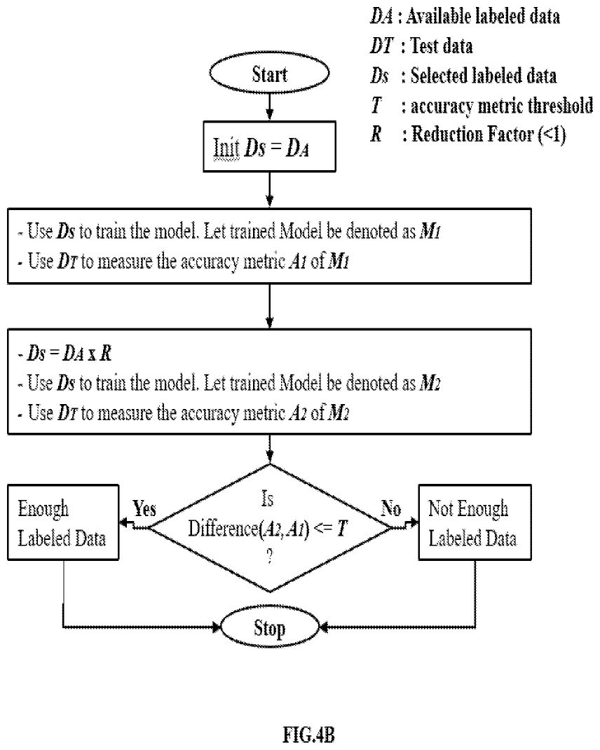

Referring now to the steps of the method 300, at step 310, the one or more hardware processors 104 construct, via a snorkel generative model (wherein the snorkel generative model is executed by the hardware processor(s) 104), a generative model for the sparse matrix to label the unlabelled dataset. Now to FIG. 4A, the method analyzes if the system 100 has enough labelled dataset for training the one or more machine learning model with the training data recommender technique. Also, it considers if the system 100 has unlabeled dataset then it labels the unlabeled dataset by employing the snorkel generative model to label the unlabeled dataset and then train the one or more machine learning models.

Referring now to the steps of the method 300, at step 310, the one or more hardware processors 104 train, the one or more machine learning models, with adequate amount of the labelled dataset for labelling the unlabeled dataset based on a labelled data prediction threshold which is determined using a training data recommender technique. Referring now to the above example, the method enables to label the unlabeled dataset by generating additional labelled dataset which is inadequate to train the one or more machine learning models. This method also extends in scenarios when zero unlabeled dataset or dataset is insufficient to generate the labelled dataset. The training data recommender technique comprises the following steps such as obtaining, information or a plurality of labeled dataset threshold parameters comprising (i) an initial labeled dataset, (ii) a reduction factor, (iii) the test data, and (v) the labelled data prediction threshold. Further, a plurality of prediction accuracy metrics of the test data associated with the labelled dataset is determined based on the one or more machine learning models. Then, a selected labeled data, is computed for each machine learning model which is the product of the initial labeled dataset, and the reduction factor. The required amount of the labeled dataset for training the one or more machine learning models is determined based on (i) the selected labeled data, (ii) the prediction accuracy metrics of the test data, and (iii) the labelled data prediction threshold.

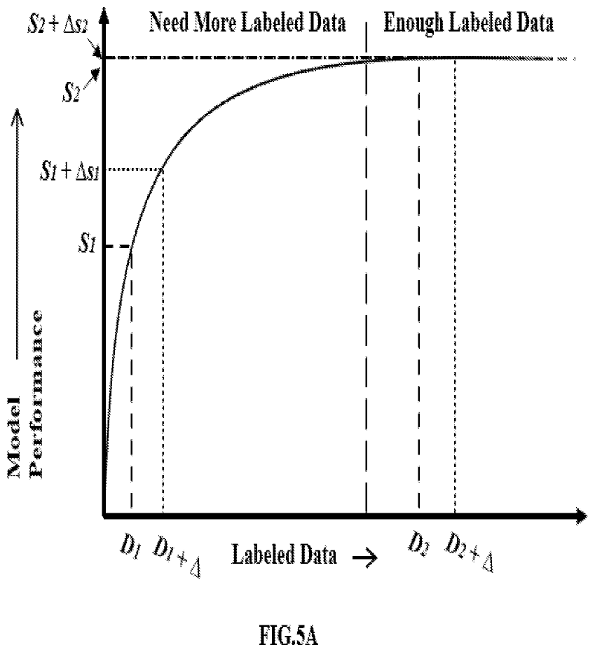

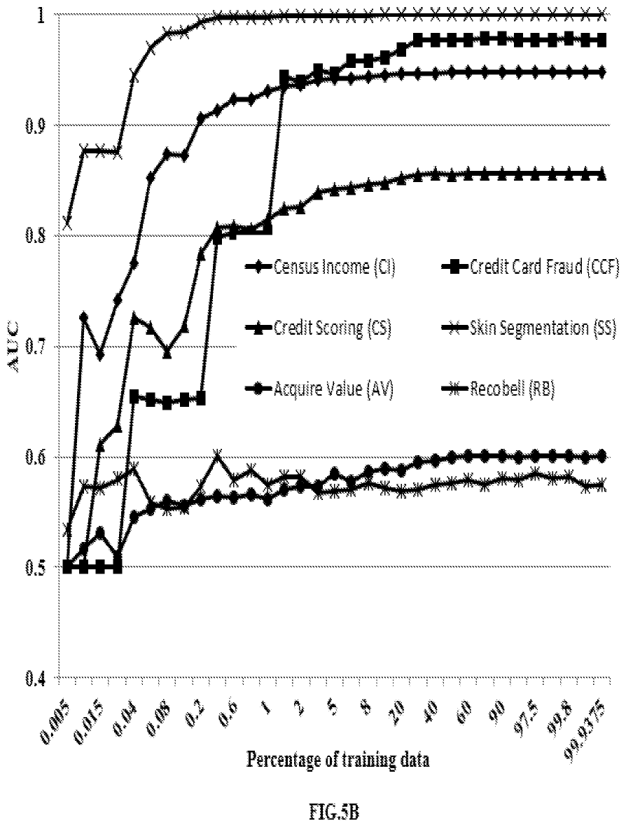

Referring now to FIG. 4B, the training data recommender technique performs the following steps, each model from the one or more machine learning model M1 is trained on all the available labeled training data Ds and the labelled data prediction threshold. Further, the selected labeled training data Ds is reduced by a reduction factor R and the accuracy metrics. Iteratively, for each machine learning model the difference between accuracy metrics is compared with the user predefined labelled data prediction threshold T wherein the comparison implies whether the amount of labeled data is enough or not. Further, the additional labeled dataset is required to label the unlabeled dataset. The steps of the method (FIG. 4B) are as follows,
Step 1: Initializing the selected labelled dataset with the labelled dataset.
Step 2: Utilizing Dₛ to train the one or more machine learning models. Let the trained one or more machine learning be denoted as M1.
   Utilizing the test data of the labelled dataset D_{T} to measure accuracy metrics (A1) of the one or more machine learning models (M1).
Step 3: Setting Dₛ=D_{A}×R
   utilizing the selected labelled dataset Dₛ to train the one or more machine learning models. Let the trained one or more machine learning models be denoted as (M2). Utilizing the test data of the labelled dataset D_{T} to measure the accuracy metrics (A2) of the one or more machine learning models (M2).
Step 4: Determining the difference between the accuracy metrics (A1) corresponding to the machine learning model with the accuracy metrics (A2) based on the labelled data prediction threshold.
   where,
Dₛ is the selected labelled dataset,
D_{A} is the available labelled dataset,
R is the reduction factor.
   This behavior is further explained using the experimental graphs as shown in FIG. 5A and FIG. 5B.

FIG. 5A and FIG. 5B illustrate performance analysis of the one or more machine learning models trained with adequate amount of labelled dataset based on a labelled data prediction threshold using the system of FIG. 1, in accordance with some embodiments of the present disclosure. The experimental graph depicts D₁ which represents the total amount of labeled data available in (X-axis) using which the one or more machine learning models are trained. The model performance is achieved (Y-axis) is A₁^{D1} (AUC1). Here, the amount of labeled dataset D₁ is decreased by the reduction factor R, and each machine learning models are retrained to obtain the performance A₂^{D1}. Now considering D₂ which is the amount of labeled dataset available for training and then iteratively each machine learning model performance of A₁^{D2} is achieved by reducing the amount of labeled data D₂ based on the reduction factor R. This further achieves A₂^{D2} better machine learning model performance. In this case the model performance reduces significantly. However, it can be derived that there exists a point on the X-axis called labelled data prediction threshold as shown in FIG. 5A using the dotted line representation. The labelled data prediction threshold is a point beyond which providing additional training data to the one or more machine learning models does not give any significant improvement in the performance metrics as the machine learning models is unable to discern any new patterns. Here, D2 is on the right and D1 is on the left of the labelled data prediction threshold. The training data recommender technique can recommend the labelled data prediction threshold, for any given structured dataset. Also, the labelled data prediction threshold is effective in reducing the training time for large datasets.

Referring now to FIG. 5B, the existence of the labelled data prediction threshold, using four real-world datasets by varying percentage of training dataset. The labelled data prediction threshold represents increasing training data does not lead to a significant improvement in the model performance. Hence, the labelled data prediction threshold is barely 2%-4% of training data in the datasets shown and on the left of the labelled data prediction threshold, the model performance degrades. The experimental data performed on the structured datasets as exampled are described in Table 1. The prediction tasks for the datasets are as follows: Census Income (CI)—Does a person's income exceed $50K in a year? Credit Scoring (CS)—Should a loan should be approved? Skin Segmentation (SS)—Is the sample a skin sample? Credit Card Fraud (CCF)—Is transaction fraudulent? Recobell (RB)—Was a product purchased? Acquire Value (AV)—Did customer repeat-purchase the product from the promotion received? We use Python 3.6.7, Snorkel 0.7.0-beta, XGBoost 0.90 on CentOS Linux 7 for our experiments.

TABLE 1
Dataset Parameters

| DataS. (prior arts) | Train | Test | Feat. | Size | |
|---|---|---|---|---|---|
| CI | 199K | 99K | 41 | 148 | MB |
| CS | 84K | 28K | 10 | 7.4 | MB |
| SS | 174K | 61K | 3 | 3 | MB |
| CCF | 213K | 71K | 30 | 143 | MB |
| RB | 292K | 44K | 6 | 450 | MB |
| AV | 160K | 151K | 68 | 2.86 | GB |

TABLE 2
HP Tuning

| | | |
|---|---|---|
| DataS. (prior arts) | Gold | Full |

| | | | | |
|---|---|---|---|---|
| CI | 79 | s | 17187 | s |
| CS | 33 | s | 2400 | s |
| SS | 10 | s | 2911 | s |
| CCF | 47 | s | 2962 | s |
| RB | 249 | s | 28859 | s |
| AV | 1550 | s | 24149 | s |

For the experiments, the method has been emulated that there is not enough labeled data, i.e., on the left of the labelled data prediction threshold (FIG. 5A). To achieve the dataset which is fully labeled and has a separate portion marked as test data then only X % of it as gold data is considered. The gold data automatically generates labeling functions and are then executed over increasing portions of the remaining (100−X) % data to generate increasing portions of labeled data shown as (X+d1) %, (X+d2) % and so on. d1 and d2 may be arbitrarily chosen. The reason for considering multiple portions is to plot an observable trend with multiple points. Available labeled data is also referred to as gold data.

In one embodiment, a discriminative model (XGBoost) is trained over these portions of data ((X+d1) %, (X+d2) % and so on) to measure the accuracy metrics over the spare test data to draw the curve. The technique/method described in the present disclosure with the trained discriminative model over increasing portions of the actual labeled dataset (again (X+d1) %, (X+d2) % and so on). Further, iterative executions are performed on each experiment to plot the averages. The closer “Auto labelling functions X” is to “No LFs” curve the better is the labeling achieved (by using only X % of available labeled data). The starting point X % of each graph on the left of the labelled data prediction threshold for each dataset, which has been determined by the training data recommender technique. The, the Time to Accuracy (TTA) metric is plotted on the secondary Y-axis. This metric illustrates to obtain desired accuracy (similar to “No labelling functions”) with lesser training data in reduced time. The experimented amount of gold data as represented (for e.g., 0.8%, 1%, 2% of the entire dataset) is utilized to generate the labelling functions. The labelling functions are then applied on the unlabeled dataset to generate labels. For example, as depicted in FIG. 5B, consider the first graph (Credit Score dataset). There are 3 “Auto LFs” curves as for 3 different values of gold data (X=1%, 1.5%, and 4%). It is observed that the model performance improves when more gold is used. For e.g., dataset CS—The area under the curve (AUC) numbers of Auto labelling functions 1, 1.5 and 4 of training data are 0.81427, 0.82498, and 0.83847 respectively. The graph of RB dataset is an exception to the trend, and it is observed by the present disclosure through experimental results that the feature set of RB is insufficient to train a good model.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address unresolved problem of determining the adequate amount of labeled dataset required for training the one or more machine learning models. The embodiment thus provides method and system for generating labelled dataset using a training data recommender technique. Moreover, the embodiments herein further provide a time efficient, accurate and scalable system for generating labelled data using the training data recommender technique. The method of the present disclosure addresses reducing the training time required to train the one or more machine learning models required for labelling the data using the proposed training data recommender technique. The method of the present disclosure is based on a training data recommender technique suitably constructed with newly defined parameters such as the labelling data threshold to determine the sufficiency of labelled training data required for the one or more machine learning models. Additionally, the method enables auto generation of labels for large amount of training dataset in a timely manner.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for generating labeled dataset using a training data recommender technique, comprising:
receiving, by a labeling function generator, via one or more hardware processors, (i) an unlabeled dataset, and (ii) a labelled dataset comprising a training data and a test data;
extracting, via the one or more hardware processors, a plurality of feature subsets from the labeled dataset;
feeding, via the one or more hardware processors, the plurality of feature subsets extracted from the labeled dataset to a one or more machine learning models;
generating, via the one or more hardware processors, a plurality of labelling functions for the labelled dataset using the one or more trained machine learning models;
executing, via the one or more hardware processors, the plurality of labelling functions for processing the unlabeled dataset to generate a sparse matrix;
constructing, by a snorkel, via the one or more hardware processors, a generative model for the sparse matrix to label the unlabelled dataset; and
training, the one or more machine learning models, via the one or more hardware processors, with required amount of labelled dataset for labelling the unlabeled dataset based on a labelled data prediction threshold which is determined using a training data recommender technique.

2. The method as claimed in claim 1, wherein the required amount of labeled dataset for training the one or more machine learning models using the training data recommender technique is determined by:
obtaining a plurality of labeled dataset threshold parameters comprising (i) an initial labeled dataset, (ii) a reduction factor, (iii) the test data, and (iv) a labelled data prediction threshold;
determining a plurality of prediction accuracy metrics of the test data associated with the labelled dataset based on the one or more machine learning models;
computing, a selected labeled data, for each machine learning model based on the initial labeled dataset, and the reduction factor; and
determining the required amount of the labeled dataset for training the one or more machine learning models based on (i) the selected labeled data, (ii) the prediction accuracy metrics of the test data, and (iii) the labelled data prediction threshold.

3. The method as claimed in claim 1, wherein the labelled dataset for training the one or more machine learning models decreases based on a reduction factor.

4. A system (100), for generating labeled dataset using a training data recommender technique comprising:
a memory (102) storing instructions;
one or more communication interfaces (106); and
one or more hardware processors (104) coupled to the memory (102) via the one or more communication interfaces (106), wherein the one or more hardware processors (104) are configured by the instructions to:
receive, by a labeling function generator, (i) an unlabeled dataset, and (ii) a labelled dataset comprising a training data and a test data;
extract, a plurality of feature subsets from the labeled dataset;
feed, the plurality of feature subsets extracted from the labeled dataset to a one or more machine learning models;
generate, a plurality of labelling functions for the labelled dataset using the one or more trained machine learning models;
execute, the plurality of labelling functions for processing the unlabeled dataset to generate a sparse matrix;
construct, by a snorkel, a generative model for the sparse matrix to label the unlabelled dataset; and
train, the one or more machine learning models with required amount of labelled dataset for labelling the unlabeled dataset based on a labelled data prediction threshold which is determined using a training data recommender technique.

5. The system (100) as claimed in claim 4, wherein the required amount of labeled dataset for training the one or more machine learning models using the training data recommender technique is determined by:
obtaining, a plurality of labeled dataset threshold parameters comprising (i) an initial labeled dataset, (ii) a reduction factor, (iii) the test data, and (iv) a labelled data prediction threshold;
determining, a plurality of prediction accuracy metrics of the test data associated with the labelled dataset based on the one or more machine learning models;
computing, a selected labeled data, for each machine learning model based on the initial labeled dataset, and the reduction factor; and
determining, the adequate amount of the labeled dataset for training the one or more machine learning models based on (i) the selected labeled data, (ii) the prediction accuracy metrics of the test data, and (iii) the labelled data prediction threshold.

6. The system (100) as claimed in claim 4, wherein the labelled dataset for training the one or more machine learning models decreases based on a reduction factor.

7. One or more non-transitory machine-readable information storage mediums comprising one or more instructions which when executed by one or more hardware processors perform actions comprising:
receiving, by a labeling function generator, (i) an unlabeled dataset, and (ii) a labelled dataset comprising a training data and a test data;
extracting, a plurality of feature subsets from the labeled dataset;
feed, the plurality of feature subsets extracted from the labeled dataset to a one or more machine learning models;
generating, a plurality of labelling functions for the labelled dataset using the one or more trained machine learning models;
executing, the plurality of labelling functions for processing the unlabeled dataset to generate a sparse matrix;
constructing, by a snorkel, a generative model for the sparse matrix to label the unlabelled dataset; and
training, the one or more machine learning models with required amount of labelled dataset for labelling the unlabeled dataset based on a labelled data prediction threshold which is determined using a training data recommender technique.

8. The one or more non-transitory machine-readable information storage mediums of claim 7, wherein the required amount of labeled dataset for training the one or more machine learning models using the training data recommender technique is determined by:
obtaining, a plurality of labeled dataset threshold parameters comprising (i) an initial labeled dataset, (ii) a reduction factor, (iii) the test data, and (iv) a labelled data prediction threshold;
determining, a plurality of prediction accuracy metrics of the test data associated with the labelled dataset based on the one or more machine learning models;
computing, a selected labeled data, for each machine learning model based on the initial labeled dataset, and the reduction factor, and
determining, the adequate amount of the labeled dataset for training the one or more machine learning models based on (i) the selected labeled data, (ii) the prediction accuracy metrics of the test data, and (iii) the labelled data prediction threshold.

9. The one or more non-transitory machine-readable information storage mediums of claim 7, wherein the labelled dataset for training the one or more machine learning models decreases based on a reduction factor.
